(19) United States
(12) Patent Application Publication
(10) Pub. No.: US 2017/0255848 A1
(43) Pub. Date: Sep. 7, 2017

(54) PRINT CONTROL DEVICE THAT FACILITATES MANAGEMENT OF PRINT JOB, CONTROL METHOD THEREFOR AND STORAGE MEDIUM, AND PRINTING SYSTEM AND CONTROL METHOD THEREFOR

(71) Applicant: CANON KABUSHIKI KAISHA, Tokyo (JP)

(72) Inventor: Ryo Fujita, Tokyo (JP)

(21) Appl. No.: 15/444,398

(22) Filed: Feb. 28, 2017

(30) Foreign Application Priority Data
Mar. 3, 2016 (JP) 2016-041115

(51) Int. Cl. G06K 15/02; G06F 3/12

(52) U.S. Cl. CPC G06K 15/1823; G06K 15/1836; G06K 15/1821; G06F 3/1213; G06F 3/122; G06F 3/1267; G06F 3/1259

(57) ABSTRACT

A print control device that facilitates management of print job. The print control device performs a processing on a print job to generate image data capable of being printed by an image forming device, transmits the generated image data to the image forming device, determines whether or not the data amount of image data that has not yet been printed by the image forming device, among the transmitted image data, exceeds a threshold value, and, in a case where the data amount of the image data that has not yet been printed exceeds the threshold value, holds transmission of image data of a subsequent print job and transmits job information that indicates an attribute of the subsequent print job and does not include image data, to the image forming device.

### BACKGROUND OF THE INVENTION

Field of the Invention

The present invention relates to print control techniques related to a print control device, a control method therefor and a storage medium, and a printing system and a control method therefor.

Description of the Related Art

Conventionally, it is common practice that a printing system is constructed by connecting a print control device that performs various kinds of processing related to print job processing, and that gives a print instruction, to an image forming device such as a complex machine. For example, the print control device performs rasterizing (RIP) processing that converts print data into a bit-mapped image, and then transmits, to an image forming device, image data that has been subjected to the RIP processing. The image forming device performs print processing of printing the received image that has been subjected to the RIP processing.

However, the print control device and the image forming device are each capable of independently operating, and therefore processing speed may differ between the RIP processing performed in the print control device and the print processing performed in the image forming device. When the RIP processing speed is higher than the print processing speed, image data that is waiting for print processing may be left in the image forming device. When the image data that is waiting for print processing is left in the image forming device, processing resources such as a CPU and a memory, which are provided in the image forming device, are largely consumed by processing of receiving/writing the image data. As the result, the processing resources are insufficient for print processing of a print job that is currently being performed, which leads to a decrease in the speed of print processing of print data that is currently being printed.

In order to prevent such a situation, in Japanese Laid-Open Patent Publication (kokai) No. 2006-270314, data transmission to an image forming device is controlled according to the remaining capacity of a storage unit provided in the image forming device, thereby limiting the number of image data to be transmitted from the print control device to the image forming device. In other words, an upper limit is put on the number of pages of image data left in the image forming device, and when the number of pages of the image data left in the image forming device exceeds the upper limit, the print control device suspends the transmission of the image data. Subsequently, when the number of pages of the left image data becomes less than the upper limit, the print control device restarts the transmission of the image data. In this manner, the image data can be prevented from being left in the image forming device without limitation, and therefore the processing speed of the printing system as a whole can be prevented from decreasing.

Incidentally, there is an image forming device that is configured to display a progress state of processing of print jobs, which are held in the image forming device, on a job situation screen as job information, thereby to allow a user to grasp the progress state. The job information displayed on the job situation screen tends to include not only a job name, a user name of a user who has given a processing instruction, a job ID, the total number of pages, but also a job state (status) such as under RIP processing and under printing.

However, when limiting the transmission of the image data as disclosed in Japanese Laid-Open Patent Publication (kokai) No. 2006-270314, job information of a part of the print jobs may not be displayed on the job situation screen of the image forming device. Even in the case of, for example, print jobs that have been put into the print control device, job information of a print job, of which the image data has not yet been transmitted to the image forming device, is not displayed.

For example, it is assumed that an upper limit of the number of pages of image data left in the image forming device is set at 120 pages. In this case, when a large number of print jobs, each of which is composed of 100 pages of print data, are put into the print control device, only image data corresponding to one or two print jobs are transmitted from the print control device to the image forming device. In such a case, the conventional image forming device displays only information of one or two print jobs, of which the processing has been started by the image forming device, on the job situation screen. In other words, not all print jobs that have been put into the print control device are displayed on the job situation screen. Therefore, there arises a case where progress states of some of the print jobs that have been put into the print control device cannot be properly grasped. In addition, a user may mistakenly understand that the RIP processing is delay in the print control device.

### SUMMARY OF THE INVENTION

An object of the present invention is to inform, even when an image forming device has not yet received image data corresponding to print jobs that have been put into a print control device, the image forming device of the existence of all of the print jobs that have been put into the print control device.

Accordingly, the present invention provides a print control device comprising a memory device that stores a set of instructions, and at least one processor that executes the instructions to perform a processing on a put print job to generate image data that is capable of being printed by an image forming device, transmit the generated image data to the image forming device, determine whether or not the data amount of image data that has not yet been printed by the image forming device, among the transmitted image data, exceeds a threshold value, and, in a case where it is determined that the data amount of the image data that has not yet been printed exceeds the threshold value, hold the transmission of image data of a subsequent print job, and transmit job information that indicates an attribute of the subsequent print job and does not include image data, to the image forming device.

According to the present invention, even when the image forming device has not yet received image data corresponding to print jobs that have been put into the print control device, it is possible to inform the image forming device of the existence of all of the print jobs that have been put into the print control device.

Further features of the present invention will become apparent from the following description of exemplary embodiments (with reference to the attached drawings).

### BRIEF DESCRIPTION OF THE DRAWINGS

FIG. 1 is a diagram showing the overall configuration of a printing system including a print control device.

FIG. 2 is a block diagram showing a schematic configuration of the print control device.

FIG. 3 is a block diagram showing a configuration of an image forming device.

FIGS. 4A to 4D are diagrams each showing a display example of a display screen of an operation unit.

FIG. 5 is a flowchart showing job processing in the print control device.

FIG. 6 is a flowchart showing job print processing in the image forming device.

### DESCRIPTION OF THE EMBODIMENTS

The present invention will now be described in detail below with reference to the accompanying drawings showing embodiments thereof.

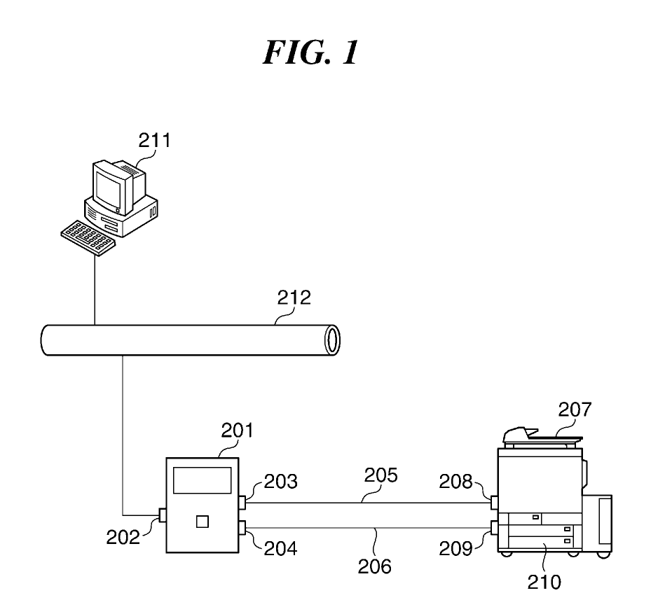

FIG. 1 is a diagram showing the overall configuration of a printing system including a print control device 201 according to one embodiment of the present invention. This printing system includes the print control device 201, an image forming device 207 and a terminal device 211.

The terminal device 211 is a computer that is connected to the print control device 201 through a LAN 212, to which plurality of terminal devices 211 can be connected. The print control device 201 and the image forming device 207 are communicably connected to each other through a LAN 205 and a dedicated line 206. The image forming device 207 includes connectors 208, 209 and a sheet feeder 210. The print control device 201 includes connectors 202, 203, 204. The connector 203 and the connector 208 are connected to each other through the LAN 205. The connector 204 and the connector 209 are connected to each other through the dedicated line 206. The connector 202 is connected to a LAN 212.

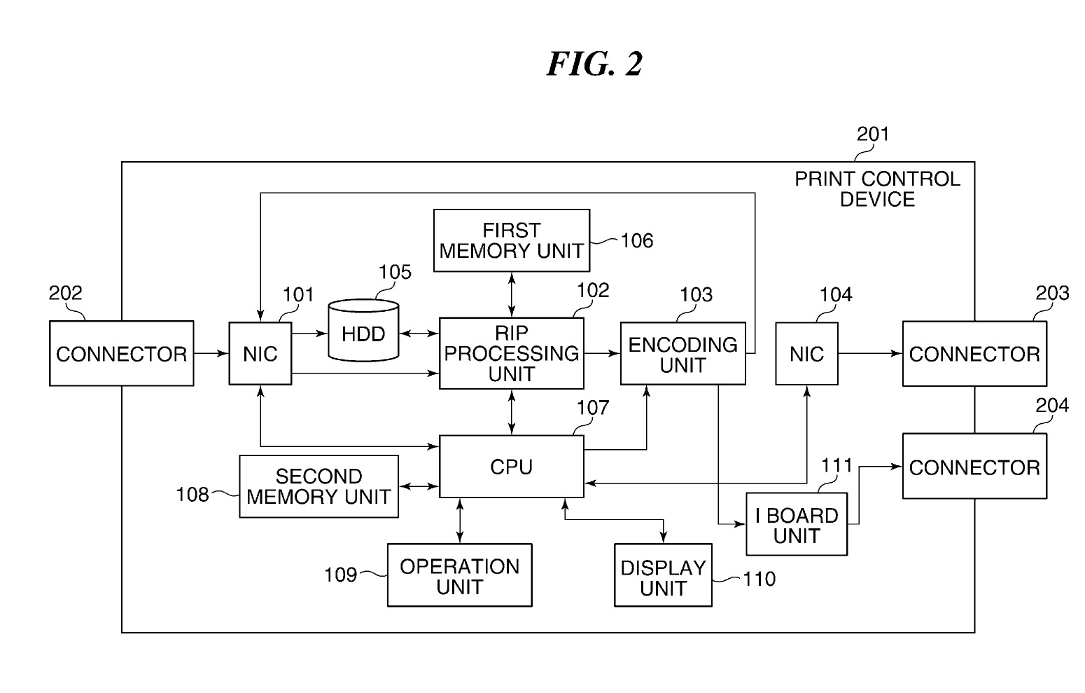

FIG. 2 is a block diagram showing a schematic configuration of the print control device 201. The print control device 201 includes a CPU 107; and the CPU 107 manages the control of the whole device.

An NIC (Network Interface Card) 101 manages the low-layer level connection to the LAN 212 through the connector 202. An RIP (Raster Image Processor) processing unit 102 as a processing unit converts print data described in Page Description Language (PDL) into a raster image such as a bit-mapped image. A NIC 104 functions as a transmission unit that manages the low-layer level connection to the LAN 205 through the connector 203.

A HDD 105 is a Hard Disk Drive (HDD) for temporarily storing print data received by the NIC 101. The HDD 105 is also capable of storing information about various kinds of setting values managed by the print control device 201. The CPU 107 is capable of reading the setting-value information from the HDD 105 and using the setting-value information as necessary, and is capable of writing, into the HDD 105, a change of the setting-value information which has been requested from the outside or through the operation 109.

A first memory unit 106 is used for image expansion processing by the RIP processing unit 102. A second memory unit 108 includes a RAM and a ROM, and is used as a temporary storage area of data by the CPU 107. The operation unit 109 includes a button, a key and a touch panel, and a user operates the print control device 201 through the operation unit 109. The connector 204 is connected to an I (image interface) board unit 111. The CPU 107 is capable of transmitting image data to the image forming device 207 through the dedicated line 206 via the I board unit 111 and the connector 204. Various kinds of information are displayed on a display unit 110.

As the basic operation of the printing system, processing of print jobs that have been put from the terminal device 211 will be described. First of all, according to an instruction input by a user through the operation unit 109, the terminal device 211 puts a print job into the print control device 201. The print job that has been put from the terminal device 211 is transferred into the print control device 201 as a network data packet through the LAN 212 and the connector 202. In the print control device 201, the NIC 101 performs reception processing of the print job (print data).

When the NIC 101 receives the print data, the CPU 107 controls the NIC 101 to store the received data into the HDD 105 as necessary. This processing is queuing (spooling) that is a common practice performed for the purpose of, for example, enhancing the data transmission speed. The data stored in the HDD 105 is read from the RIP processing unit 102 by the control of the CPU 107. Meanwhile, print data that has not been queued is directly transmitted to the RIP processing unit 102 by the control of the CPU 107.

The RIP processing unit 102 subjects the received print data to rasterizing (RIP) processing, thereby converting the received print data into a raster image. Next, on the basis of a format of the generated raster image and a preset data format that can be interpreted by the image forming device 207, an encoding unit 103 performs encoding processing to encode the raster image into the data format that can be interpreted by the image forming device 207. In this manner, image data that can be printed by the image forming device 207 is generated. As an example of the encoding processing, there is, for example, data compression processing that is carried out for the purpose of reducing the amount of data to be transmitted to the image forming device 207.

Such encoding processing is performed as necessary. For example, when the image forming device 207 is capable of interpreting the generated raster image without performing encoding processing, or when it is not necessary to reduce the amount of data, the encoding processing can be skipped. Data obtained by the encoding processing is required to have a format that can be interpreted by the image forming device 207. The format is, for example, a specific print language format, or a data format of data that is compressed by a specific method such as JBIG. The required format depends on the capability of an interpretation function that is built into the image forming device 207.

The image data that has been encoded as necessary in this manner is converted into data packets again by the NIC 104 to transmit to the LAN 205. The data packets are transmitted from the connector 203, and thereafter are transmitted to the image forming device 207 through the LAN 205. The image forming device 207 receives the data packets through the connector 208, and then supplies paper from the sheet feeder 210 to perform print processing in conformity to print processing procedures of the image forming device 207 itself. The dedicated line 206 can also be used as another route through which the encoded image data is transmitted. In this case, the CPU 107 transmits the image data to the I board unit 111 through the encoding unit 103, and transmits the image data to the image forming device 207 through the connector 204 and the dedicated line 206.

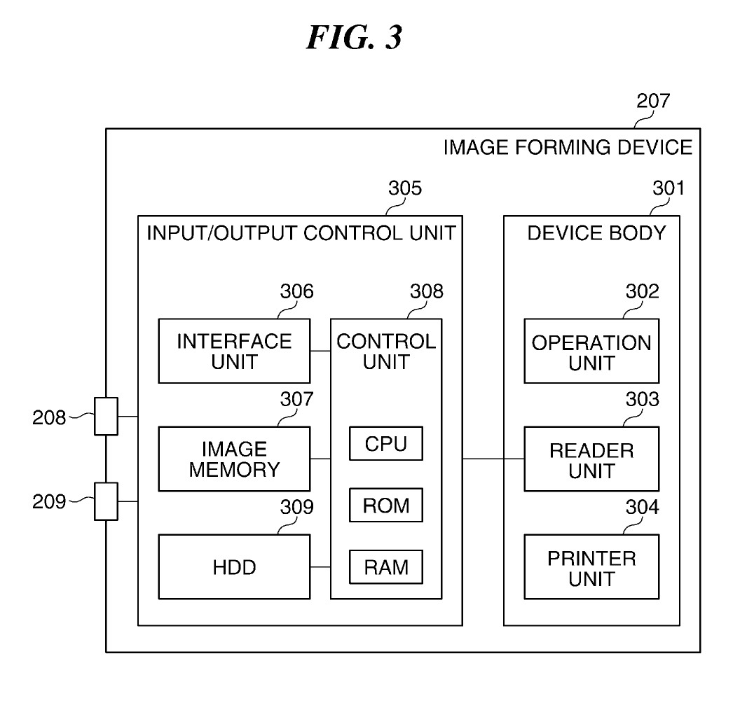

FIG. 3 is a block diagram showing a configuration of the image forming device 207. The image forming device 207 includes a device body 301 and an input/output control unit 305. The device body 301 includes an operation unit 302, a reader unit 303 and a printer unit 304. The input/output control unit 305 includes a control unit 308, an interface unit 306, an image memory 307 and a HDD (hard disk) 309.

The operation unit 302 is used for operating the device body 301 and the input/output control unit 305. The operation unit 302 includes a display screen, and the after-mentioned job situation screen is displayed on the display screen. The reader unit 303 reads an original image, and outputs image data based on the original image to the printer unit 304 and the input/output control unit 305. The printer unit 304 records, on the recording paper, an image based on the image data obtained from the reader unit 303 and the input/output control unit 305.

The input/output control unit 305 is connected to the reader unit 303. The HDD 309 stores various kinds of setting values of the image forming device 207 such as an address book, an operation history, user settings, ID settings, and network settings. The interface unit 306 is an interface between the control unit 308 and the print control device 201 connected to the terminal device 211 on the LAN 212.

The interface unit 306 receives the encoded image data transmitted from the print control device 201 through the connector 208 or the connector 209, and expands the received encoded image data into image data that can be recorded by the printer unit 304, and then transmits the expanded image data to the control unit 308. The control unit 308 is composed of a CPU, a ROM, a RAM and the like.

The CPU of the control unit 308 loads, on the RAM, a program stored in the ROM or other storage medium to execute the program, and controls flow of the data among the reader unit 303, the interface unit 306, the image memory 307 and the like. It should be noted that as an alternative to the HDD 309, another nonvolatile memory can be provided so as to store programs and data therein.

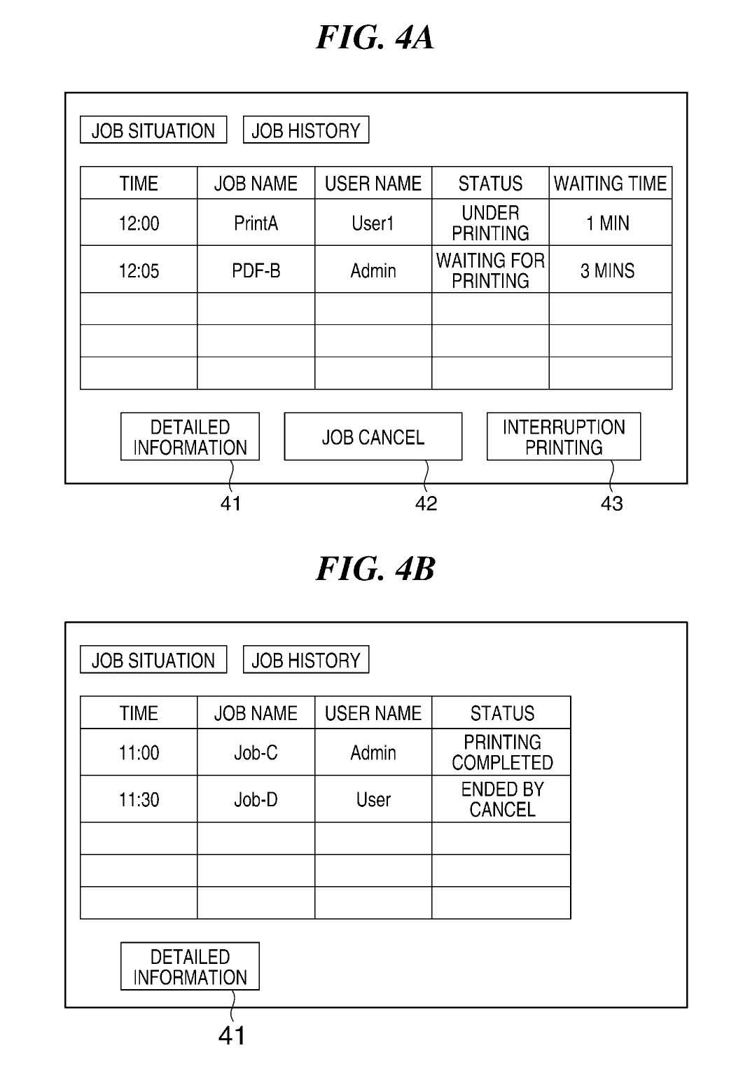

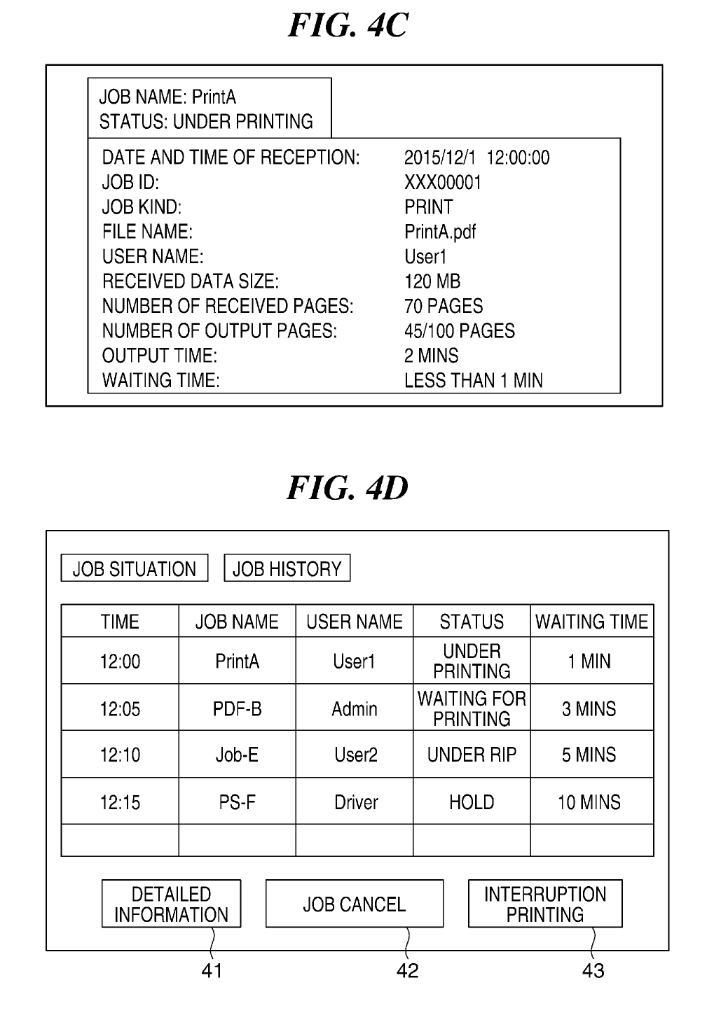

FIGS. 4A to 4D are diagrams each showing a display screen of the operation unit 302 of the image forming device 207 as a display example. In particular, each of FIGS. 4A, 4B and 4D shows an example of the job situation screen.

Although the details will be described later, when the print control device 201 instructs the image forming device 207 to execute a print job (print processing), transmission of image data of the print job can be limited depending on a progress states of print of the transmitted image data, for example, depending on the amount of data of non-printed pages. When the transmission of the image data is limited, image data of the subsequent print job is not transmitted, but job information thereof is transmitted. Here, the job information is information that indicates an attribute of the print job, but does not contain image data. It should be noted that, for example, a job ID is used for associating job information with image data on a print job basis.

FIG. 4C shows display of detailed job information. The job information includes a job ID, a job name, a user name, the number of pages, paper to be used, and a job status (hereinafter referred to as “status”). The status represents a status of processing of the corresponding print job. The status includes, for example, “hold” indicating a state in which a job is received, and also includes, as a progress state of the RIP processing, “under RIP” indicating that the RIP processing is being executed, and “RIP completed” indicating that the RIP processing has been completed.

Besides the above, the status includes “waiting for printing” indicating a state of waiting for the start of printing in the image forming device 207, “under printing” indicating that print processing is currently being executed in the image forming device 207, and the like. When the status is “waiting for printing” or “under printing”, the waiting time is also a part of the job information. Besides the above, the status is also prepared for a job, of which the print processing has been completed, and thus includes, for example, “printing completed” indicating that the print processing has been normally completed, “ended by cancel” indicating that a job has ended by the cancel operation by a user, and “ended by error” indicating that a job has ended by an error that has occurred in the print control device 201 or the image forming device 207.

As shown in FIGS. 4A, 4B and 4D, job information is displayed on the job situation screen of the image forming device 207. It should be noted that job information that is displayed on the job situation screen can be at least a part of the job information, and therefore is not limited to the above-mentioned example. Job information that is displayed on the job situation screen is composed of job information that has been received by the image forming device 207, and therefore also includes job information of a print job, of which the image data has not yet been received by the image forming device 207. For example, displayed job information shown in FIGS. 4A and 4B is job information of print jobs, of which the image data has been received. Meanwhile, in FIG. 4D, job information, of which the job names are “Job-E” or “PS-F”, is job information of print job, of which the image data has not yet been received by the image forming device 207.

It should be noted that when a user selects one piece of job information and then presses a detailed information button 41 with the job situation screen, the display of the display screen changes to the detailed display of the selected job information (FIG. 4C).

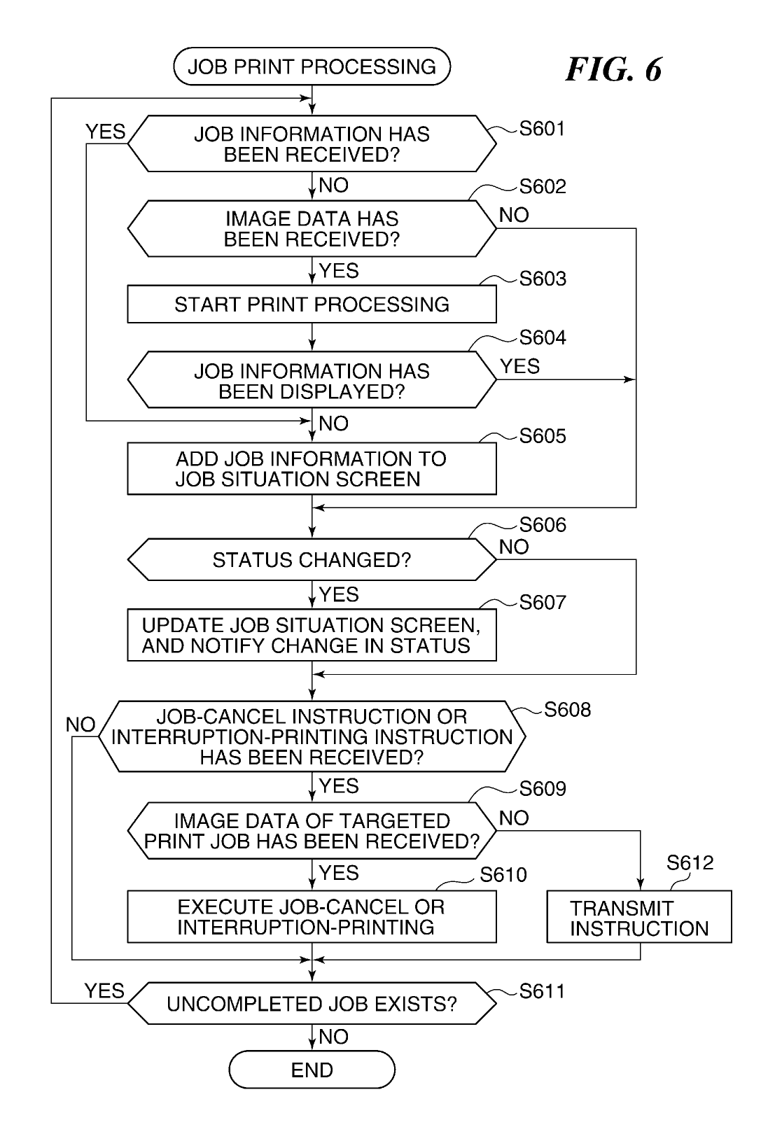

The details will be described later (explanation in FIG. 6). However, it is assumed that the user selects one piece of job information and then presses a job cancel button 42 in a state where printing is not completed. In this case, when a print job corresponding to the selected job information is a print job, of which the image data has already been received by the image forming device 207, the control unit 308 cancels the print job (step S610 in FIG. 6). It should be noted that in such a case, the selected job information is deleted from the display. Meanwhile, when the print job corresponding to the selected job information is a print job, of which the image data has not yet been received by the image forming device 207, the control unit 308 transmits an instruction to cancel the print job to the print control device 201 (step S612 in FIG. 6).

In addition, it is assumed that the user selects one piece of job information and then presses an interruption printing button 43 in a state where print processing is not completed or canceled. In this case, when a print job corresponding to the selected job information is a print job, of which the image data has already been received by the image forming device 207, the control unit 308 performs print processing of the print job by priority (step S610 in FIG. 6). Meanwhile, when the print job corresponding to the selected job information is a print job, of which the image data has not yet been received by the image forming device 207, the control unit 308 transmits an instruction to transmit image data of the print job by priority to the print control device 201 (step S612 in FIG. 6).

Incidentally, for example, the display unit 110 in the print control device 201 also displays a job situation screen similar to the job situation screen shown in each of FIGS. 4A, 4B and 4D. The print control device 201 and the image forming device 207 exchange a change in status of processing and a change in status related to a print job therebetween, and update the respective displays of the job situation screens at any time.

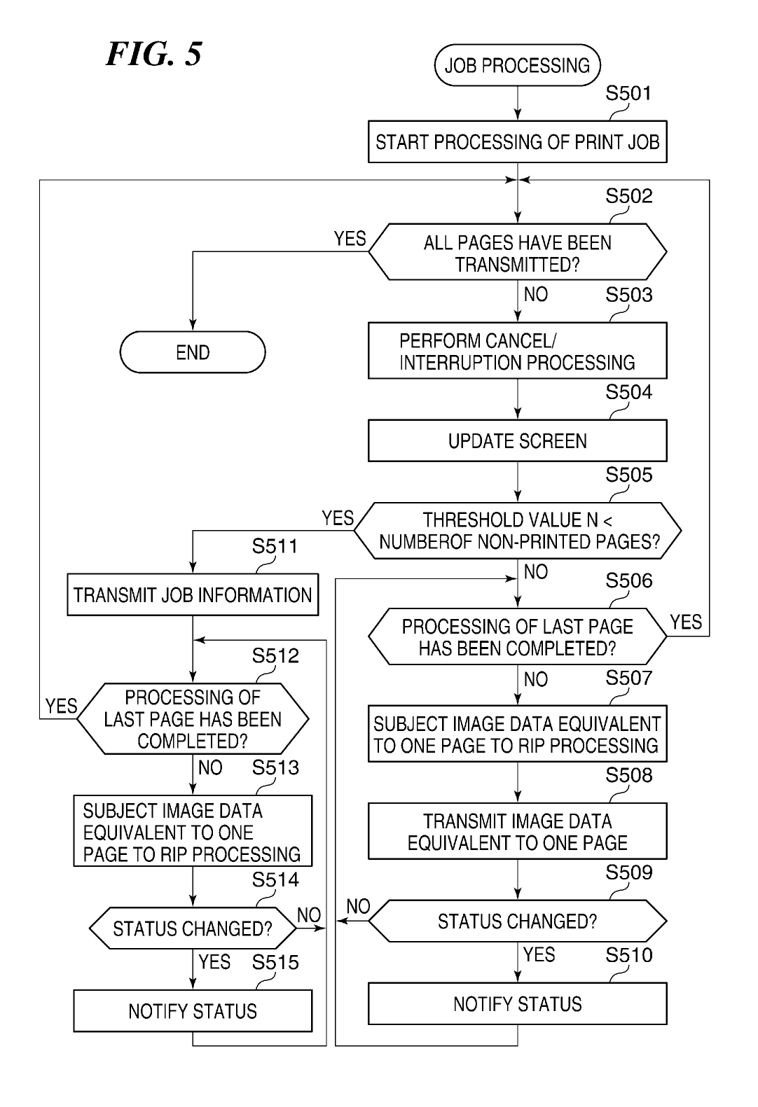

FIG. 5 is a flowchart showing job processing in the print control device 201. This job processing is implemented by the execution of software processing by the CPU 107 on the basis of a program stored in the HDD 105 or the ROM of the second memory unit 108, which is provided in the print control device 201. This job processing is started when a power source of the device is switched on.

First of all, on receipt of an instruction to start print processing, the CPU 107 starts processing of a print job (step S501). When a user uses the operation unit 109 to select a print job and to perform predetermined operation, the instruction to start the print processing is transmitted to the CPU 107. In addition, the user can give an instruction to start print processing by putting a print job into the print control device 201 by using software such as a printer driver of the terminal device 211. It should be noted that the print control device 201 and the image forming device 207 are both capable of receiving an instruction to start print processing for a plurality of print jobs in the arbitrary timing.

When the CPU 107 receives the instruction to start the print processing and then starts the processing of the print job, the CPU 107 causes the display unit 110 to display an initial screen of the job situation screen (not shown). Next, the CPU 107 determines whether or not all pages of image data of all put print jobs have been transmitted to the image forming device 207, the image data having been subjected to the RIP processing (step S502). Hereinafter, the image data that has been subjected to the RIP processing may be merely abbreviated as “image data”.

In step S502, when all pages of image data of all print jobs have been transmitted, the process shown in FIG. 5 is terminated. However, when image data that has not yet been transmitted remains, for example, immediately after the processing of the print job is received, the process proceeds to step S503. In step S503, when the CPU 107 has already received an instruction to cancel the print job (job-cancel) or an interruption-printing instruction from the image forming device 207, the CPU 107 cancels the corresponding print job or performs interruption processing (change the printing order). The job-cancel instruction and the interruption-printing instruction are each transmitted in the after-mentioned step S612 shown in FIG. 6.

Next, the CPU 107 updates the job situation screen of the display unit 110 in response to a change in status of the print job in the image forming device 207 (step S504). More specifically, when the job is canceled or when the interruption processing is executed, at step S503, the CPU 107 updates the job situation screen by reflecting the cancellation or the interruption processing therein.

In addition, when the status of the print job in the image forming device 207 changes, the image forming device 207 notifies the print control device 201 of the change in status of the print job in the after-mentioned step S607 in FIG. 6. For example, the print control device 201 receives an under-printing notification, a printing-completed notification, an ended-by-error notification or the like in response to the start of printing and the completion of printing for the print job, the end of the job caused by the occurrence of an error, or the like. In this case as well, the job situation screen of the display unit 110 is updated in response to a change in status.

Next, the CPU 107 functions as a determination unit, and determines whether or not the amount of data of pages, of which the printing has not yet been completed (“non-printed page” or “non-printed image data”), among image data transmitted to the image forming device 207 up to this time, exceeds a threshold value N (step S505). Here, it is assumed that “the start of the print job processing” in FIG. 5 is a starting point of the start of transmission of the transmitted image data.

The amount of data is expressed by the number of image data (“the number of pages”), but is not limited to this. The amount of data is calculated by subtracting the total number of times the above-described printing-completed notification has been received, from the total number of image data transmitted by the print control device 201. It should be noted that among image data that has been transmitted to the image forming device 207, image data, of which the print processing has not yet been completed, is called “left image data”. In addition, the total number of left image data, in other words, the amount of data of non-printed pages, is called “the number of non-printed pages”. The threshold value N is a value that is predetermined according to the printing capability or the like of the image forming device 207.

As the result of the determination in step S505, when the number of non-printed pages does not exceed the threshold value N (NO in step S505), the process proceeds to step S506. Meanwhile, when the number of non-printed pages exceeds the threshold value N (YES in step S505), the process proceeds to step S511. In step S506, the CPU 107 determines whether or not processing for the last page in the image data of the print job to be subjected to the processing has been completed. As the result of the determination, when the processing for the last page has not yet been completed, the CPU 107 causes the process to proceed to step S507.

In step S507, the CPU 107 controls the RIP processing unit 102 to subject image data equivalent to one page of image data of the print job to be subjected to the RIP processing. It should be noted that when the corresponding image data has already been subjected to the RIP processing, this processing can be omitted. Next, the CPU 107 controls the NIC 104 to transmit the image data equivalent to one page that has been subjected to the RIP processing to the image forming device 207 (step S508).

Next, the CPU 107 determines whether or not the status of the print job that is currently being performed has changed (step S509). When it is determined that the status has not changed, the CPU 107 returns the process to step S506. Meanwhile, when it is determined that the status has changed, the CPU 107 controls the NIC 104 to transmit a detected new status to the image forming device 207 (step S510). Here, it is considered that the change in status is a change from “under RIP” to “RIP completed”, or “ended by error” or the like. Subsequently, the CPU 107 returns the process to step S506. As the result of the determination in step S506, when the processing of the last page has been completed, the CPU 107 returns the process to step S502.

When the process proceeds to step S511 (YES in step S505), it is necessary to limit the transmission of the image data. Here, the CPU 107 functions as a control unit, and thus controls the NIC 104 to hold the transmission of image data of a subsequent print job, and to transmit job information of the subsequent print job (step S511).

Here, the subsequent print job means a print job that should be subjected to the RIP processing next, in other words, a print job to be subjected to the RIP processing first among unprocessed print jobs, and a print job to be subjected to the RIP processing thereafter. During the transmission of the job information in step S511, the CPU 107 notifies the image forming device 207 that a status of the print job to be subjected to the RIP processing next is “under RIP”. In addition, the CPU 107 notifies the image forming device 207 that a status of the print job to be subjected to the RIP processing thereafter is “hold”.

It should be noted that during the processing in step S511 in the second round or more of the process, it is not absolutely necessary to transmit the already transmitted job information again unless the status of the print job changes. In this manner, even in the case of a print job, of which the image data has not yet been transmitted to the image forming device 207, transmitting job information of the print job to the image forming device 207 in advance enables to inform the image forming device 207 of the existence of the print job which has been put into the print control device 201, but the image data of which has not yet been transmitted to the image forming device 207.

In steps S512, S513, S514 and S515, processings similar to those in steps S506, S507, S509 and S510 are executed. With respect to the subsequent print job, processing corresponding to step S508 is not executed. Therefore, image data of the subsequent print job is not transmitted. Next, as the result of the determination in step S512, when the processing (here the RIP processing) for the last page has been completed, the CPU 107 returns the process to step S502. Therefore, in steps S511 to S515, the print control device 201 subjects each page of image data to the RIP processing, but the print control device 201 does not transmit the image data to the image forming device 207.

It is considered that the change in status notified in step S515 is a change from “hold” to “under RIP”, a change from “under RIP” to “RIP completed”, “ended by error” or the like. It should be noted that the notification of the change in status in step S515 can be achieved by retransmission of the job information of the subsequent print job.

Not transmitting image data enables the image forming device 207 to concentrate on print processing of received image data without allocating processing resources to reception processing of the image data. The print control device 201 is capable of adjusting a processing load of the image forming device 207 on the basis of the number of left image data, in this manner. In addition, even in the case of a print job, the image data of which is temporarily brought into a non-transmission state, when the print processing progresses in the image forming device 207, with the result that (the threshold value N) (the number of non-printed pages) is satisfied, the transmission of the image data in steps S507 to S510 is restarted thereafter. In this case, it is not necessary to subject a print job, for which the required RIP processing has already been completed in step S513, to the RIP processing again, and therefore the job processing becomes faster.

FIG. 6 is a flowchart showing job print processing in the image forming device 207. This job print processing is implemented by the execution of software processing by the CPU of the control unit 308 on the basis of a program stored in the HDD 309 or the ROM of the control unit 308, which is provided in the image forming device 207. This job print processing is started when the image forming device 207 receives job information or image data from the print control device 201. The process shown in FIG. 6 can be executed in parallel with the processing shown in FIG. 5. When this job print processing is started, an initial screen of a job situation screen is first displayed in the operation unit 302 of the image forming device 207.

First of all, the control unit 308 determines whether or not the image forming device 207 has received job information (step S601). When it is determined that the image forming device 207 has received job information, the process proceeds to step S605, and the job situation screen is updated by adding the job information that has been received this time. For example, the job situation screen is updated from the screen in FIG. 4A to the screen in FIG. 4D. After that, the process proceeds to step S606.

Meanwhile, in step S601, when it is determined that the image forming device 207 has not received job information, the control unit 308 determines whether or not the image forming device 207 has received new image data (step S602). As the result of the determination, when it is determined that the image forming device 207 has not received new image data, the control unit 308 causes the process to proceed to step S606. Meanwhile, when it is determined that the image forming device 207 has received new image data, the control unit 308 starts print processing of the new image data (step S603).

Next, the control unit 308 determines, on the basis of a job ID associated with the image data, whether or not job information of a print job corresponding to the new image data is already displayed on the job situation screen (step S604). As the result of the determination, when it is determined that the job information is already displayed on the job situation screen, the control unit 308 causes the process to proceed to step S606. Meanwhile, when it is determined that the job information is not displayed on the job situation screen, the control unit 308 adds the job information to the job situation screen to update the screen (step S605).

Therefore, job information of a print job, of which the job information has been received without image data of the print job received, and job information of a print job, for which print processing has been started after the reception of the image data of the print job, are displayed together on the same job situation screen (FIG. 4D, etc.). Therefore, irrespective of whether or not the image forming device 207 has already received image data, a list of print jobs that have been put into the print control device 201 is displayed on the job situation screen. Accordingly, the user can grasp all of the print jobs that have been put into the print control device 201, and therefore can easily manage the print jobs.

In step S606, the control unit 308 determines whether or not a status of a print job that is currently being processed has changed. There are the following two ways of change in status. One is a case where a change in status can be detected by the image forming device 207. This case includes a case where print processing of the last page of a print job is completed, and consequently a status thereof has changed to “printing completed”, and a case where an error occurs in the image forming device 207, and consequently a status of a print job has changed to “ended by error”. The other is a case where the print control device 201 detects a change in status of a print job, and consequently the image forming device 207 has received the status transmitted in step S510 or S515 in FIG. 5.

In step S606, when it is determined that the status of the print job that is currently being performed has not changed, the control unit 308 causes the process to proceed to step S608. Meanwhile, when it is determined that the status of the print job that is currently being performed has changed, the control unit 308 causes the process to proceed to step S607. In step S607, the control unit 308 updates the status displayed on the job situation screen in response to the change in status. In addition to updating the displayed status, the control unit 308 controls the interface unit 306 to notify the print control device 201 of the change in status detected in the image forming device 207.

With respect to the updating of the displayed status, when a user cancels printing by the cancel operation, the status of the print job having the job name “Job-D” changes to “ended by cancel” as shown in FIG. 4B. When notifying the print control device 201, the status is changed from “waiting for printing” to “ended by cancel”. In addition, when printing has been completed, the status of the print job having a job name “Job-C” changes to “printing completed” as shown in FIG. 4B. When notifying the print control device 201, the status is changed from “under printing” to “printing completed”. It should be noted that when the job situation screen is updated, not only the status, but also the order of displaying jobs and an area in which the jobs are displayed can be changed.

Next, the control unit 308 determines whether or not to have received, from a user, an instruction to cancel the job by the job cancel button 42 pressed, or an instruction to perform interruption printing by the interruption printing button 43 pressed, for a print job displayed on the job situation screen (step S608). Here, the job-cancel instruction and the interruption-printing instruction can be targeted for not only a print job, of which the image data has already been received by the image forming device 207, but also a print job, of which the image data has not yet been received by the image forming device 207.

In step S608, when it is determined that a job-cancel instruction or an interruption-printing instruction has not been received, the process proceeds to step S611. Meanwhile, when it is determined that a job-cancel instruction or an interruption-printing instruction has been received, the control unit 308 determines whether or not a print job targeted by the instruction is a print job, of which the image data has already been received by the image forming device 207 (step S609).

As the result of the determination, when it is determined that the print job targeted by the instruction is a print job, of which the image data has already been received by the image forming device 207, the control unit 308 cancels the print job targeted by the instruction or executes interruption printing for the print job targeted by the instruction in the image forming device 207 (step S610). Meanwhile, when it is determined that the print job targeted by the instruction is not a print job, of which the image data has already been received by the image forming device 207, the control unit 308 notifies the print control device 201 of the job ID of the print job targeted by the instruction and instruction content (step S612).

By use of the notification, for example, when the instruction content is job cancel, the control unit 308 requests the print control device 201 to cancel the corresponding print job. By use of the notification, for example, when the instruction content is interruption printing, the control unit 308 requests the print control device 201 to execute processing (RIP, etc.) for transmitting the corresponding print job by priority.

In the print control device 201, the processing corresponding to the notification is executed in step S503 in FIG. 5. In other words, when the CPU 107 receives a notification, of which the instruction content is cancel, the CPU 107 cancels the print job targeted by the instruction. In this case, even when (the threshold value N)<(the number of non-printed pages) is not satisfied in the subsequent step S505, the canceled print job is not recovered.

In addition, when the CPU 107 receives a notification that the instruction content is interruption printing, the CPU 107 turns the print job targeted by the instruction into a targeted print job to be processed next. More specifically, the CPU part 107 sets the priority to restart the transmission of image data of the print job, of which the transmission is held and which is targeted by the instruction, higher than that of the other print jobs, each of which the image data has not been transmitted. At that time, display ranking of a print job, which has the highest priority, that is to say, the print job targeted by the instruction, is also moved to a higher level on the job situation screen.

After the process of step S610 or S612, the control unit 308 causes the process to proceed to step S611. In step S611, the control unit 308 determines whether or not an uncompleted job, of which the print processing has not yet been completed, exists. When it is determined that an uncompleted job exists, the control unit 308 returns the process to step S601. Meanwhile, when it is determined that an uncompleted job does not exist, the control unit 308 terminates the process shown in FIG. 6.

According to the present embodiment, when the data amount of non-printed image data exceeds the threshold value N, the transmission of image data of a subsequent print job is held, and job information of the subsequent print job is transmitted in advance. Regarding any print job that has been put into the print control device 201, this makes it possible to inform the image forming device 207 of the existence of the print job and related information of the print job, even in a state where the image forming device 207 has not yet received image data of the print job. In addition, since the image forming device 207 adds the received job information to the job situation screen, the user can also grasp the situation of the print job, of which the image data has not yet been received by the image forming device 207, with reference to the job situation screen, and therefore can manage progress states of all print jobs.

In addition, when a status of a print job, of which the job information has already been transmitted from the print control device 201 to the image forming device 207 and the image data has not yet been transmitted, changes, the print control device 201 notifies the image forming device 207 of the change in status, to thereby enable to inform the status of the print job, of which the image data has not yet been transmitted to the image forming device 207. The job situation screen of the image forming device 207 is updated in response to the received change in status, which makes a user possible to always grasp statuses of the latest print jobs.

In addition, after the image-data transmission is held in the print control device 201, when the amount of data comes not to exceed the threshold value N, the transmission of image data that has been held is restarted. Therefore, the transmission of the image data that has been temporarily held can be quickly restarted.

Moreover, a job-cancel instruction and an interruption-printing instruction can also be received for a print job, of which the image data has not yet been received by the image forming device 207, through the job situation screen of the image forming device 207. Therefore, a user is capable of not only grasping the job situation of all print jobs, but also instructing to perform processing for all print jobs. Therefore, even when the print control device 201 receives, from the image forming device 207, a job-cancel instruction to cancel a print job, of which the job information has already been transmitted to the image forming device 207 and the image data has not yet been transmitted to the image forming device 207, the print control device 201 cancels the print job, which makes it possible to avoid useless transmission of the image data.

Furthermore, when the print control device 201 receives an interruption-printing instruction, the print control device 201 sets the priority to restart the transmission of image data of the print job, of which the transmission is held and which is targeted by the instruction, higher than that of the other print jobs, each of which the image data has not yet been transmitted. Therefore, the usability can be enhanced.

It should be noted that in step S511 in FIG. 5, the targeted “subsequent print job”, of which the image-data transmission is to be held and the job information is to be transmitted, can be only a print job that is subjected to the RIP processing next.

It should be noted that in the present embodiment, the transmission of the image data of the subsequent print job is held on a print job basis. However, the present invention is not limited to this case. The image-data transmission can be held, for example, on a page basis, or on a predetermined data amount basis. In a case where the image-data transmission is held, for example, on a page basis, some pages of the image data of the subsequent print job has been transmitted, and the other pages has not been transmitted.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-41115, filed Mar. 3, 2016, which is hereby incorporated by reference wherein in its entirety.

What is claimed is:

1. A print control device comprising:
a memory device that stores a set of instructions; and
at least one processor that executes the instructions to:
perform a processing on a put print job to generate image data that is capable of being printed by an image forming device;
transmit the generated image data to the image forming device;
determine whether or not the data amount of image data that has not yet been printed by the image forming device, among the transmitted image data, exceeds a threshold value; and
in a case where it is determined that the data amount of the image data that has not yet been printed exceeds the threshold value, hold the transmission of image data of a subsequent print job, and transmit job information that indicates an attribute of the subsequent print job and does not include image data, to the image forming device.

2. The print control device according to claim 1,
wherein in a case where, after the transmission of the image data of the subsequent print job is held, it is determined that the amount of the image data comes not to exceed the threshold value, at least one processor executes the instruction to restart the held transmission of the image data.

3. The print control device according to claim 1,
wherein in a case where a cancel instruction to cancel a print job, of which the job information has already been transmitted and the image data has not yet been transmitted, is received from the image forming device, at least one processor executes the instruction to cancel a print job targeted by the cancel instruction.

4. The print control device according to claim 2,
wherein in a case where an instruction to perform interruption processing for a print job, of which the job information has already been transmitted and the image data has not yet been transmitted, is received from the image forming device, at least one processor executes the instruction to set the priority to restart transmission of the image data of the print job, of which the transmission is held and which is targeted by the instruction to perform the interruption processing, higher than that of the other print jobs, each of which the image data has not yet been transmitted.

5. The print control device according to claim 1,
wherein in a case where a status of the print job, of which the job information has already been transmitted and the image data has not yet been transmitted, has changed, at least one processor executes the instruction to notify the image forming device of the change of the status.

6. The print control device according to claim 5,
wherein the notification of the change of the status is performed by retransmission of the job information of the subsequent print job.

7. The print control device according to claim 5,
wherein the processing for generating image data that is capable of being printed by the image forming device includes RIP processing, and the status includes a progress state of the RIP processing.

8. A printing system comprising a print control device, and an image forming device that is communicably connected to the print control device and has a display unit,
wherein the print control device comprises:
a first memory device that stores a set of instructions; and
at least one first processor that executes the instructions to:
perform a processing on a put print job to generate image data that is capable of being printed by the image forming device;
transmit the generated image data to the image forming device;
determine whether or not the data amount of image data that has not yet been printed by the image forming device, among the transmitted image data, exceeds a threshold value; and
in a case where it is determined that the data amount of the image data that has not yet been printed exceeds the threshold value, hold the transmission of image data of a subsequent print job, and transmit job information that indicates an attribute of the subsequent print job and does not include image data, to the image forming device,
wherein the image forming device comprises:
a second memory device that stores a set of instructions; and
at least one second processor that executes the instructions to:
display, on the basis of the job information received from the print control device, the job information of the print job that has been put into the print control device, on the display unit.

9. The printing system according to claim 8,
wherein the display unit of the image forming device displays job information of the print job, of which the image data has already been received, and job information of the print job, of which the image data has not yet been transmitted, together with each other.

10. The printing system according to claim 9,
wherein in a case where a status of a print job, of which the job information has already been transmitted and the image data has not yet been transmitted, has changed, the at least one first processor of the print control device executes the instruction to notify the image forming device of the change of the status.

11. The printing system according to claim 10,
wherein the display unit of the image forming device updates, on the basis of the notification of the change of the status, indication of the status of the put print job displayed on the display unit.

12. A printing control method, comprising:
a generating step of performing a processing on a put print job to generate image data that is capable of being printed by an image forming device;
a transmission step of transmitting the generated image data to the image forming device;
a determination step of determining whether or not the data amount of image data that has not yet been printed by the image forming device, among the transmitted image data, exceeds a threshold value; and
a control step of, in a case where it is determined that the data amount of the image data that has not yet been printed exceeds the threshold value, holding the transmission of image data of a subsequent print job, and transmitting job information that indicates an attribute of the subsequent print job and does not include image data, to the image forming device.

13. A method for controlling a printing system comprising a print control device, and an image forming device that is communicably connected to the print control device,
wherein the print control device executes:
a generating step of performing a processing on a put print job to generate image data that is capable of being printed by the image forming device;
a transmission step of transmitting the generated image data to the image forming device;
a determination step of determining whether or not the data amount of image data that has not yet been printed by the image forming device, among the transmitted image data, exceeds a threshold value; and
a control step of, in a case where it is determined that the data amount of the image data that has not yet been printed exceeds the threshold value, holding the transmission of image data of a subsequent print job, and transmitting job information that indicates an attribute of the subsequent print job and does not include image data, to the image forming device, and
wherein the image forming device executes:
a display step of displaying, on the basis of the job information received from the print control device, the job information of the print job that has been put into the print control device.

14. A computer-readable non-transitory storage medium storing a program for causing a computer to execute a printing control method, the printing control method comprising:
a generating step of performing a processing on a put print job to generate image data that is capable of being printed by an image forming device;
a transmission step of transmitting the generated image data to the image forming device;
a determination step of determining whether or not the data amount of image data that has not yet been printed by the image forming device, among the transmitted image data, exceeds a threshold value; and
a control step of, in a case where it is determined that the data amount of the image data that has not yet been printed exceeds the threshold value, holding the transmission of image data of a subsequent print job, and transmitting job information that indicates an attribute of the subsequent print job and does not include image data, to the image forming device.
